(19) United States
(12) Patent Application Publication
(10) Pub. No.: US 2014/0240897 A1
(43) Pub. Date: Aug. 28, 2014

(54) MULTILAYER CERAMIC DEVICE

(71) Applicant: Samsung Electro-Mechanics Co., Ltd., Suwon-si (KR)

(72) Inventors: Hae Sock CHUNG, Suwon-si (KR); Youn Sik JIN, Suwon-si (KR); Na Rim HA, Suwon-si (KR); Sang Hyun PARK, Suwon-si (KR); Doo Young KIM, Suwon-si (KR)

(73) Assignee: SAMSUNG ELECTRO-MECHANICS CO., LTD., Suwon-si (KR)

(21) Appl. No.: 14/189,839

(22) Filed: Feb. 25, 2014

(30) Foreign Application Priority Data
Feb. 26, 2013 (KR) 10-2013-0020383

(51) Int. Cl. H01G 4/30

(52) U.S. Cl. CPC H01G 4/30
USPC 361/301.4

(57) ABSTRACT

Disclosed herein is a multilayer ceramic device, including a device body having a plurality of dielectric sheets stacked on one another, the device body having spaced-apart sides and circumferential surfaces connecting the sides; internal electrodes formed on the dielectric sheets; an external electrode having a front portion to cover the sides and a band portion to extend from the front portion to cover parts of the circumferential surfaces; and a reinforcement pattern having a plurality of metal patterns arranged facing one another between the internal electrodes and the circumferential surfaces, wherein a distance between the metal patterns may be smaller than thicknesses of the dielectric sheets on which the internal electrodes are formed.

### CROSS REFERENCE(S) TO RELATED APPLICATIONS

This application claims the benefit under 35 U.S.C. Section 119 of Korean Patent Application Serial No. 10-2013-0020383, entitled “Multilayer Ceramic Device” filed on Feb. 26, 2013, which is hereby incorporated by reference in its entirety into this application.

### BACKGROUND OF THE INVENTION

1. Technical Field

The present invention relates to a multilayer ceramic device, and more particularly to a multilayer ceramic device in which deterioration due to cracks is prevented.

2. Description of the Related Art

Chip components such as typical thin film multilayer ceramic condensers (MLCC) include a device body, an internal electrode, and an external electrode. The device body has a structure in which a plurality of dielectric sheets, referred to as green sheets, are stacked, and the internal electrode is provided on each of the dielectric sheets. Further, the external electrode is electrically connected to the internal electrode and covers both ends of the device body.

Normally, since multilayer ceramic devices are designed to focus on improvement of device characteristics, they are relatively vulnerable to physical pressure or impact, thermal impact, vibrations and the like from the outside. Therefore, a crack occurs in the device body when a physical or thermal impact is applied to a multilayer ceramic device. Usually, a crack occurs on a surface of the device body adjacent to an end of the external electrode and then propagates inward of the device body. Once the crack reaches the active region of the device body, the device may become non-functional.

A technology to prevent damages on chip components is known in which an external electrode is made capable of absorbing impacts from the outside. To that end, the external electrode may include an internal metal layer to directly cover the device body, an external metal layer exposed to the outside, and an intermediate layer interposed between the internal metal layer and the external metal layer. However, the intermediate layer is made of mixture of a metal and a polymer resin, and the polymer resin is thermodegraded during a reflow process or wave soldering process for mounting the chip components, such that the intermediate layer and the internal metal layer have a gap therebetween, thereby causing a void. Such void and delamination problems are matters of a chip component itself, irrelevant to the operation of an electronic device having the chip component therein, resulting in a deterioration of the chip component.

### RELATED ART DOCUMENT

### Patent Document

(Patent Document 1) Korean Patent Laid-Open Publication No. 10-2006-0047733

### SUMMARY OF THE INVENTION

An object of the present invention is to provide a multilayer ceramic device capable of preventing a crack from occurring due to impacts from the outside.

According to an exemplary embodiment of the present invention, there is provided a multilayer ceramic device, including: a device body having a plurality of dielectric sheets stacked one another, the device body having spaced-apart sides and circumferential surfaces connecting the sides; internal electrodes formed on the dielectric sheets; an external electrode having a front portion to cover the sides, and a band portion to extend from the front portion to cover parts of the circumferential surfaces; and a reinforcement pattern having a plurality of metal patterns arranged facing one another between the internal electrodes and the circumferential surfaces, wherein distances between the metal patterns are smaller than thicknesses of the dielectric sheets in which the internal electrodes are formed.

A ratio of the distance between the metal patterns to the thickness of the dielectric sheets on which the internal electrodes are formed may be greater than 0.100.

A ratio of the distance between the metal patterns to the thickness of the dielectric sheets on which the internal electrodes are formed may be less than 0.950.

A ratio of the distance between the metal patterns to the thickness of the dielectric sheets on which the internal electrodes are formed may be greater than 0.100 and less than 0.950.

The distance between the metal patterns may be smaller than the distance between the internal electrodes.

The reinforcement pattern may be extended inward of the device body from the sides, and a length of the reinforcement pattern may be equal to or longer than a length of the band portion.

The multilayer ceramic device may include: an active region in which the internal electrodes are arranged; and a non-active region other than the active region, wherein the reinforcement pattern may be disposed in the non-active region.

According to another exemplary embodiment of the present invention, there is provided a multilayer ceramic device, including: a device body having an active region and a non-active region; internal electrodes arranged facing one another in the active region; an external electrode covering both ends of the device body and being electrically connected to the internal electrodes; and a reinforcement pattern having metal patterns arranged facing the internal electrodes in the non-active region, wherein a distance between metal patterns is smaller than a thickness of the dielectric sheets in the active region.

A ratio of the distance between the metal patterns to the thickness of the dielectric sheets on which the internal electrodes are formed may be greater than 0.100.

A ratio of the distance between the metal patterns to the thickness of the dielectric sheets may be less than 0.950.

The distance between the metal patterns may be smaller than the distance between the internal electrodes.

### BRIEF DESCRIPTION OF THE DRAWINGS

FIG. 1 is a view showing a multilayer ceramic device according to an exemplary embodiment of the present invention.

### DESCRIPTION OF THE PREFERRED EMBODIMENTS

Various advantages and features of the present invention and methods for accomplishing the same will become apparent from the following descriptions of exemplary embodiments with reference to the accompanying drawings. However, the present invention may be modified in many different ways and it should not be considered to be limited to the embodiments set forth herein. Rather, these embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless specifically mentioned otherwise, a singular form includes a plural form in the present specification. Throughout this specification, the word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In the drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes. For example, an etching region with a square shape may be rounded or may have a predetermined curvature.

Hereinafter, a multilayer ceramic device according to exemplary embodiments of the present invention will be described in detail with reference to the accompanying drawings.

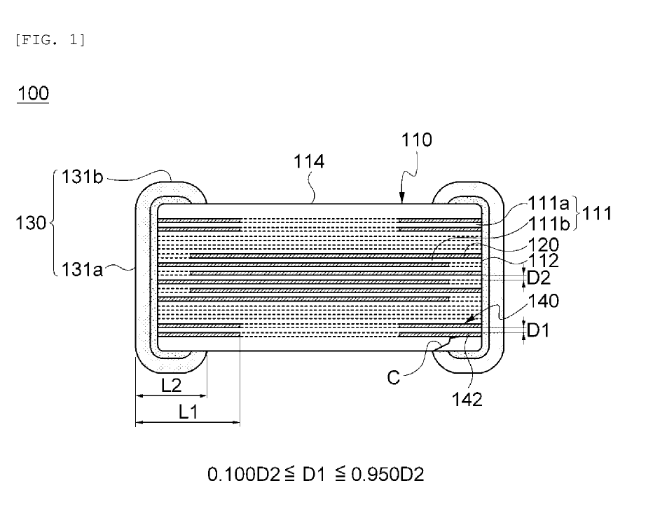

FIG. 1 is a view showing a multilayer ceramic device according to an exemplary embodiment of the present invention. Referring to FIG. 1, the multilayer ceramic device 100 according to the exemplary embodiment of the invention may include a device body 110, internal electrodes 120, external electrodes 130, and reinforcement patterns 140.

The device body 110 may have a multilayer structure in which a plurality of sheets are stacked. Such sheets may be dielectric sheets 111 which are so-called “green sheets,” and stacked in a generally hexahedron shape. The device body 110 may have two spaced-apart sides 112 and four circumferential surfaces 112 connecting the sides to each other. The device body 110 may be divided into an active region and a non-active region. The active region may generally be an internal region of the device body in which the internal electrodes 120 are located. The non-active region may generally be an external region of the device body 110 in which the internal electrodes 120 are not located, which is a region other than the active region.

The internal electrodes 120 may be arranged in generally parallel to the longitudinal direction of the device body 110. The internal electrodes 120 may be circuit patterns formed on the respective dielectric sheets 111, and may be arranged facing each other in the device body 110. The internal electrodes 120 may be metal patterns contacting on the external electrodes 130 at the sides. Each of the internal electrodes 120 may be formed on the respective sheets, and may be extended inward of the device body 110 from the sides 112. Optionally, the internal electrodes 120 may further include floating patterns. The floating patterns may be arranged between sides 112 in the device body 110 without having contacts with the external electrodes 130.

The external electrodes 130 may cover both ends of the device body 110. The external electrode 130 consists of a front portion 131a which covers the side 112, and a band portion 131b which extends from the front portion 131a to cover parts of the circumferential surfaces 114. The band portion 131b may be a bonding portion for bonding the multilayer ceramic device 100 to an external device (not shown) such as a circuit board.

The reinforcement patterns 140 may be provided for preventing cracks C from occurring in the device body 110 or for preventing the cracks C having occurred from propagating into the active region. For example, in the case that the multilayer ceramic device 100 has been incorporated into an electronic device (not shown) to constitute a structure, if impact is applied to the structure, then cracks C may occur in the multilayer ceramic device 100. Such cracks C mainly occur at the end of the band portion 131b and at the boundaries between the circumferential surfaces 114, and the cracks may be developed to propagate into the active region of the device body 110. If the cracks C propagate into the active region of the device body 110, a defect may occur in the multilayer ceramic device 100. Therefore, the reinforcement patterns 140 keep the device 100 functionally operable by preventing cracks C from occurring or blocking the propagation of the cracks C into the active region once they have occurred.

The reinforcement patterns 140 may include a plurality of metal patterns 142 which are arranged facing each other in the non-active region. The metal patterns 142 may be formed of a variety of metals. Preferably, the length of those metal patterns 142 (referred herein to as “the first length L1”) may be equal to or longer than the length of the band portion 131b (referred herein to as “the second length L2”). If the first length L1 is shorter than the second length L2, the area of the reinforcement patterns 140 to cope with the crack C is so small that the crack C may circumvent the reinforcement 140 to propagate into the active region of the device body 110.

In addition, the distance between the metal patterns 142 (referred herein to as “the first distance D1” may be narrower than the distance between the internal electrodes 120 (referred herein to as “the second distance D2”). The fact that the first distance D1 is shorter than the second distance D2 may mean that the thickness of the sheets forming the non-active region (referred hereinafter to “the first sheet 111a”) is thinner than the thickness of the sheets forming the active region (referred hereinafter to “the second sheet 111b”). Under the same area, the thinner the thickness of the dielectric sheets is, the more number of dielectric sheets can be stacked, thereby increasing durability. For this reason, in order to increase durability of the non-active region in which the reinforcement pattern 140 is provided higher than durability of the active region, the thickness of the first sheets 111a is thinner than that of the second sheets 111b, thereby resulting in increase of the durability of the non-active region.

Preferably, the first distance D1 is about 0.150 μm, and more preferably is about 0.100 μm or more. If the first distance D1 is less than 0.100 μm, the thickness of the first sheet 111a is too thin to be manufactured, and it is also quite difficult to form the metal patterns 142 on the first sheet 111a. Moreover, the minimum thickness of 0.1 μm is required to prevent an electrical short between the internal electrodes 120 due to metal expansion during a firing process, and to ensure that the second sheet 111b can be processed for manufacturing an active region. Accordingly, the thickness of the first sheet 111a should be 0.1 μm or more to thereby increase durability of the non-active region for preventing a crack C while maintaining manufacturing efficiency of the non-active region in which the reinforcement patterns 140 are provided.

As described above, a multilayer ceramic device 100 may include a device body 110 including an active region in which internal electrodes 120 are located and a non-active region other than the active region, an external electrode 130 covering both ends of the device body 110, and a reinforcement pattern 140 consisting of metal patterns 142 facing each other in the non-active region to prevent a crack from occurring, in which the distance of the metal patterns 142 D1 is shorter than the distance of the internal electrode 120 D2. In this configuration, it is possible to increase durability of the non-active region of the device body 110 so that a crack is prevented in the device body 110 and the crack C having occurred is prevented from propagating into the active region, thereby keeping the multilayer ceramic device 100 functional. That is, the multilayer ceramic device according to an exemplary embodiment of the present invention may include reinforcement patterns that are capable of preventing a crack from occurring in the device body or preventing a crack having occurred from propagating into the active region, thereby preventing deterioration due to the crack.

### EXAMPLE

500 multilayer ceramic devices with the size of 1.6 mm×0.8 mm×0.8 mm and the capacitance of 1 nF were manufactured. In the manufacturing process, the thickness of dielectric sheets forming the active region of the device body and the thickness of dielectric sheets forming the non-active region were adjusted as indicated in Tables 1 and 2, such that the first distance D1 and the second distance D2 were adjusted to yield the ratios of the second distance D2 to the first distance D1, D2/D1.

For flexural strength evaluation, 500 samples under different conditions were bent to 5 mm at 1 mm/sec, then the number of the samples in which resultant cracks track had been guided following a crack guide pattern were counted using an internal destructive polishing analysis (DPA).

For delamination evaluation, the manufactured chips had undergone the DPA and then the number of samples having delamination between the dielectrics and the electrodes were counted using an optical microscope.

The flexural strength and delamination evaluations for the samples classified according to the ratios of the second distance D2 to the first distance D1 are summarized in Tables 1 and 2 below:

TABLE 1

| D1 (μm) | D2 (μm) | D1/D2 | Delamination | Flexural strength |
|---|---|---|---|---|
| 0.03 | 0.90 | 0.033 | 24/100 | 0/500 |
| 0.06 | 0.90 | 0.067 | 8/100 | 0/500 |
| 0.09 | 0.90 | 0.100 | 3/100 | 0/500 |
| 0.10 | 0.90 | 0.111 | 0/100 | 0/500 |
| 0.12 | 0.90 | 0.133 | 0/100 | 0/500 |
| 0.30 | 0.90 | 0.333 | 0/100 | 0/500 |
| 0.50 | 0.90 | 0.556 | 0/100 | 0/500 |
| 0.70 | 0.90 | 0.778 | 0/100 | 0/500 |
| 0.80 | 0.90 | 0.889 | 0/100 | 0/500 |
| 0.85 | 0.90 | 0.944 | 0/100 | 0/500 |
| 0.86 | 0.90 | 0.956 | 0/100 | 4/500 |
| 0.90 | 0.90 | 1.000 | 0/100 | 14/500 |
| 1.00 | 0.90 | 1.111 | 0/100 | 31/500 |

TABLE 2

| D1 (μm) | D2 (μm) | D1/D2 | Delamination | Flexural strength |
|---|---|---|---|---|
| 0.03 | 1.50 | 0.020 | 13/100 | 0/500 |
| 0.06 | 1.50 | 0.040 | 7/100 | 0/500 |
| 0.09 | 1.50 | 0.060 | 3/100 | 0/500 |
| 0.12 | 1.50 | 0.080 | 5/100 | 0/500 |
| 0.15 | 1.50 | 0.100 | 2/100 | 0/500 |
| 0.30 | 1.50 | 0.200 | 0/100 | 0/500 |
| 0.50 | 1.50 | 0.333 | 0/100 | 0/500 |
| 0.70 | 1.50 | 0.467 | 0/100 | 0/500 |
| 1.30 | 1.50 | 0.867 | 0/100 | 0/500 |
| 1.40 | 1.50 | 0.933 | 0/100 | 0/500 |
| 1.42 | 1.50 | 0.947 | 0/100 | 0/500 |
| 1.43 | 1.50 | 0.953 | 0/100 | 5/500 |
| 1.50 | 1.50 | 1.000 | 0/100 | 19/500 |
| 1.60 | 1.50 | 1.067 | 0/100 | 24/500 |

As can be seen from Tables 1 and 2, delamination occurred if the ratio of the first distance D1, which is the distance between metal patterns forming the reinforcement patterns, to the second distance D2, which is the distance between internal electrodes, is below 0.100. This results from that if the ratio of D1/D2 is below 0.100, the thickness of the dielectric sheets forming the non-active region (i.e., the first sheet 111a in FIG. 1) is excessively thin, such that a metal pattern formed on the first sheet 111a may lose adhesion to be separated or the first sheets 111a may lose bonding strength therebetween and are separated from each other. Accordingly, it is preferable that the ratio of D1/D2 be 0.100 or more.

In contrast, it can be seen that a crack occurred in the flexural strength evaluation if the ratio of the first distance D1, which is the distance between metal patterns forming the reinforcement patterns, to the second distance D2, which is the distance between internal electrodes, is above 0.950. If the ratio of D1/D2 is above 0.950, the thickness of the dielectrics forming the non-active region of the device body (i.e., the first sheet 111a in FIG. 1) and the thickness of the dielectrics forming the active region (i.e., the second sheet 111b in FIG. 1) became similar. This means that the thickness of the first sheet 111a becomes thicker, and thus durability to prevent a crack was not ensured in the non-active region, such that a crack occurred. On the other hand, since multilayer ceramic devices tend to be downsized and thinned, it is undesirable to increase the ratio of D1 to D2 to above 0.950, resulting an increased thickness of the non-active region. Accordingly, it is preferable that the ratio of D1/D2 be about 0.950 or less.

As stated above, the multilayer ceramic device according to an exemplary embodiment of the present invention includes reinforcement patterns that are capable of preventing a crack from occurring in the device body or preventing a crack from propagating into the active region, thereby preventing deterioration due to the crack.

The present invention has been described in connection with what is presently considered to be practical exemplary embodiments. In addition, the above-mentioned description discloses only the exemplary embodiments of the present invention. Therefore, it is to be appreciated that modifications and alterations may be made by those skilled in the art without departing from the scope of the present invention disclosed in the present specification and an equivalent thereof. The exemplary embodiments described above have been provided to explain the best mode in carrying out the present invention. Therefore, they may be carried out in other modes known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A multilayer ceramic device, comprising:
a device body having a plurality of dielectric sheets stacked on one another, the device body having spaced-apart sides and circumferential surfaces connecting the sides;
internal electrodes formed on the dielectric sheets;
an external electrode having a front portion to cover the sides, and a band portion to extend from the front portion to cover parts of the circumferential surfaces; and
a reinforcement pattern having a plurality of metal patterns arranged facing one another between the internal electrodes and the circumferential surfaces,
wherein a distance between the metal patterns are smaller than a thickness of the dielectric sheets on which the internal electrodes are formed.

2. The device according to claim 1, wherein a ratio of the distance between the metal patterns to the thickness of the dielectric sheets on which the internal electrodes are formed is greater than 0.100.

3. The device according to claim 1, wherein a ratio of the distance between the metal patterns to the thickness of the dielectric sheets on which the internal electrodes are formed is less than 0.95.

4. The device according to claim 1, wherein a ratio of the distance between the metal patterns to the thickness of the dielectric sheets on which the internal electrodes are formed is greater than 0.100 and less than 0.95.

5. The device according to claim 1, wherein the distance between the metal patterns is smaller than a distance between the internal electrodes.

6. The device according to claim 1, wherein the reinforcement pattern is extended inward of the device body from the sides, and a length of the reinforcement pattern is equal to or longer than a length of the band portion.

7. The device according to claim 1, comprising: an active region in which the internal electrodes are arranged; and a non-active region other than the active region, wherein the reinforcement pattern is disposed in the non-active region.

8. A multilayer ceramic device, comprising:
a device body having an active region and a non-active region;
internal electrodes arranged facing one another in the active region;
an external electrode covering both ends of the device body and being electrically connected to the internal electrodes; and
a reinforcement pattern having metal patterns arranged facing the internal electrodes in the non-active region,
wherein a distance between metal patterns is smaller than a thickness of the dielectric sheets in the active region.

9. The device according to claim 8, wherein a ratio of the distance between the metal patterns to the thickness of the dielectric sheets on which the internal electrodes are formed is greater than 0.100.

10. The device according to claim 8, wherein a ratio of the distance between the metal patterns to the thickness of the dielectric sheets on which the internal electrodes are formed is less than 0.95.

11. The device according to claim 8, wherein the distance between the metal patterns is smaller than a distance between the internal electrodes.
